(19) United States
(12) Patent Application Publication
(10) Pub. No.: US 2011/0224474 A1
(43) Pub. Date: Sep. 15, 2011

(54) Advanced Microwave System for Treating Radioactive Waste

(75) Inventor: Mark S. DENTON, Knoxville, TN (US)

(73) Assignee: KURION, INC., Oak Ridge, TN (US)

(21) Appl. No.: 13/036,809

(22) Filed: Feb. 28, 2011

Related U.S. Application Data
(60) Provisional application No. 61/312,019, filed on Mar. 9, 2010.

(51) Int. Cl. G21F 9/08; F26B 3/347

(52) U.S. Cl. 588/20; 34/259

(57) ABSTRACT

Systems and methods for reducing the volume of radioactive waste materials through desiccation, pyrolysis and vitrification carried out by microwave heating. The final product of the advanced microwave system is a dryer, denser, compacted waste product. The invention comprises systems in which a layer of waste material is treated by microwaves within a hopper before deposited within the final waste container; systems in which a thin layer of waste material is treated by microwaves after it has been deposited within the final waste container; and systems in which waste material is treated by microwaves within a hopper before being deposited within the final waste container.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

The present invention relates to the treatment and disposal of radioactive waste and more particularly to systems and processes for drying, pyrolyzing and vitrifying radioactive waste materials in order to reduce the volume of waste material.

2. Description of the Related Art

The stabilization and disposition of radioactive waste is a complex field that includes a number of techniques and methods. In some processes, radioactive isotopes that are the by-products of nuclear reactions are combined with various admixture materials designed to isolate and capture specific radioactive isotopes or to render the immediate nuclear by-products safer and easier to manipulate. The various admixture materials, collectively referred to herein as “media,” include a number of inorganic and organic substances, including some organic resins. The mixture comprising media and radioactive isotopes is generally referred to herein as “radioactive waste,” “waste material,” or simply “waste.”

The disposal of radioactive waste material is an expensive process that is highly dependent upon the volume of waste material being disposed. Therefore, it is highly desirable to find methods and systems for compacting waste material, thereby reducing the volume of waste material to be disposed or stored.

Other stabilization technologies can offer some volume reduction to varying degrees depending on the additives and volumes required. While volume reduction of inorganic sludges is limited by the nature of the material (i.e. totally inorganic and not able to undergo pyrolysis), organic sludges or organic resins can undergo much higher volume reductions when totally pyrolyzed.

### BRIEF SUMMARY OF THE INVENTION

Disclosed herein are systems and processes for reducing the volume of radioactive waste materials through desiccation and, in some cases, pyrolysis or vitrification, with the treatment of the waste materials carried out by microwave heating. In some embodiments of the present invention, the advanced microwave system for treating radioactive waste material comprises a microwave applicator that directs microwaves at a thin layer of radioactive waste material moving along a conveyor belt toward a waste container. The thickness or depth of the layer of waste material is such that the full depth of the layer is completely penetrable by the microwaves. In other embodiments, the advanced microwave system comprises a microwave applicator positioned to direct microwaves at a thin layer of radioactive waste material deposited within the waste container. Again, the thickness or depth of the layer of waste material is such that the full depth of the layer is completely penetrable by the microwaves. In still other embodiments, the advanced microwave system comprises a microwave applicator positioned to direct microwaves at a mass of radioactive waste material inside a hopper that feeds waste material into a waste container. In many of these embodiments, the waste container that receives the radioactive waste material is a long-term or permanent storage vessel for the final waste product.

The advanced microwave system generally is part of a larger system for stabilizing radioactive waste and is adapted to receive a radioactive solid or slurry waste feed. The waste feed is the result of raw radioactive waste being processed by other components of a larger system.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of one embodiment of the invention;

FIG. 2 is a representative diagram of one embodiment of the invention, showing the advanced microwave system being used in connection with a waste feed carried by a conveyor belt;

FIG. 3A is a section view of another embodiment of the invention, in which waste material is treated by microwaves after a thin layer of waste material is added to the waste container;

FIG. 3B is a section view of the embodiment as shown in FIG. 3A;

FIG. 3C is a section view of the embodiment as shown in FIGS. 3A and 3B;

FIG. 4 is a block diagram of another embodiment of the invention, in which waste material is treated by microwaves within a hopper before being deposited within the final waste container;

FIG. 5 is a perspective view of one embodiment of the invention, with a hopper for receiving waste material, the waste material being treated by microwaves within the hopper before being deposited in a waste container;

FIG. 6 is a perspective view of the embodiment shown in FIG. 5, with a wall of the hopper partially removed to show the interior of the hopper;

FIG. 7A is a top-down view of the embodiment shown in FIGS. 5 and 6, showing the section line along which the view of FIG. 6B is taken;

FIG. 7B is a section view of the embodiment shown in FIGS. 5, 6, and 7A;

FIG. 8 is a section view of another embodiment of the invention, with a hopper for receiving waste material, the waste material being treated by microwaves within the hopper before being deposited in a waste container.

### DETAILED DESCRIPTION OF THE INVENTION

The present invention provides an advanced microwave system for creating a layer of radioactive waste material having a thickness that is completely penetrable by microwaves and for applying microwaves thereto. The advanced microwave system generally is part of a larger system for stabilizing radioactive waste and is adapted to receive a radioactive solid or slurry waste feed. The waste feed is the result of raw radioactive waste being processed by other components of a larger system. More specifically, in some embodiments, the waste feed is the result of the raw radioactive waste being subjected to total suspended solids (TSS) removal, total dissolved solids (TDS) removal, foulant removal, preconcentration, and purification. The solid waste feed includes resins, sludges, evaporator bottoms, and salt wastes.

The advanced microwave system manipulates the waste material into a layer of waste material and subjects the layer to the microwave applicator. In one embodiment, the layer of waste material is moved through the microwave applicator by way of a conveyor belt or similar feed system. As the layer of waste material is moved through the microwave applicator, the microwave applicator applies microwaves to the layer. Application of the microwaves to the layer of waste material heats and melts the mixture, generating a pyrolyzed product or molten glass after initiating the process of vitrification. Generally, heating radioactive waste to stabilize the waste for the purpose of safe disposal is known in the art.

The thickness of the layer of waste material is such that the layer is completely penetrable by the microwaves. More specifically, microwaves have a specific “depth of penetration” with respect to radioactive waste. Accordingly, if the thickness of the radioactive waste is greater than the depth of penetration of the microwaves, the microwaves do not reach the inner-most portions of the waste such that the entirety of the radioactive waste is not treated. However, when the layer of waste material is completely penetrable by the microwaves, the entirety of the mixture is treated by the microwaves, producing a uniform waste product. Thin-layer microwave treatment of radioactive waste shows superior results compared to several other methods of treating radioactive waste, such as in-can melting, which can be prone to produce foaming, voids, and pockets of unreacted or untreated waste material.

After being moved through the microwave applicator, the layer of waste material is received by the fillhead assembly, which funnels the mixture to the container. Once in the container, the waste material cools and forms a stable pyrolyzed product or vitrifies into a stable glass material if glass forming additives are added. The waste material is sealed within the container, and the container is stored and/or disposed of in accordance appropriate regulations.

In some embodiments of the advanced microwave system, a layer of waste material is constantly being moved through, under or near a microwave applicator or waveguide as the applicator or waveguide applies microwaves to the layer of waste material. (Hereinafter, “microwave applicator” is used to refer to both applicators and waveguides unless otherwise noted.) Accordingly, the system provides a continuous feed of waste material to the microwave applicator, increasing the efficiency of the microwave treatment process. However, it should be noted that it is not required that the layer of waste material be constantly moved through the microwave applicator to remain within the scope or spirit of the present invention.

In another embodiment of the advanced microwave system, the microwave applicator is positioned with respect to the container such that it applies the microwaves to the layer of waste material after the layer has been deposited within the container. More specifically, after the waste material is manipulated into the layer of waste material, the layer is applied to the bottom of the container, where the microwave applicator applies the microwaves to the layer in accordance with the above discussion. Another layer of the waste material is applied to the previously treated layer, and the microwave applicator applies the microwaves to the most recently applied layer. This process of applying a layer and treating the layer is performed until the container is filled to capacity or to a specified limit. Because the microwave applicator is applying the microwaves to only one layer at time, the waste material is fully treated in accordance with the above discussion. Additionally, in this embodiment, the advanced microwave system is also able to provide a continuous feed of waste material to the container, and thus to the microwave applicator, increasing the efficiency of the treatment process.

In experimental tests, a number of materials were pyrolyzed in a microwave chamber. A microwave chamber with rotating table was connected to a vacuum device, which maintained a partial vacuum within the chamber during active microwave treatment of test materials. A microwave waveguide comprising a circulator, a directional coupler, and a four-stub tuner, was connected by way of an e-plane bend into a window of the microwave chamber. A 3 kW microwave power supply (220 V, 35 Amp, single phase) powered the waveguide. The waveguide circulator was connected to a water reservoir, which provided circulating water to cool the waveguide. In initial tests, test materials were placed in 3-inch diameter quartz tubes surrounded by insulating material. For the initial tests, test materials were heated with 700 Watts at 2450 MHz for two minutes. Test materials included a number of minerals and resins similar to those used as media for capturing radioactive isotopes in making radioactive waste materials. Table 1 shows the internal temperature (or coupling temperature) of various test materials after two minutes (all materials started at 70 degrees Fahrenheit):

Table 1
End Temperatures of Test Materials After Two Minutes

| Test Material | End Temperature (° F.) |
|---|---|
| Herschelite (Chabazite-Na) | 440 |
| (Na, Ca, K) AlSi₂O₆•3 H₂O | |
| K0052-Dow 5 Anion Exchange | 333 |
| Resin, Chloride Form | |
| SBG1P Anion Exchange Resin | 330 |
| RTI-6851 | |
| Amberlite IR122 Na Ion Exchange | 300 |
| Resin | |
| CGB•BL Sodium Form Cation | 278 |
| Exchange RTP-6822 | |
| Z sume | 270 |
| LSR-33 Ion Exchange Resin | 180 |

In subsequent tests, a number of test materials were treated in the microwave chamber for more extended periods to achieve complete or near-complete pyrolysis of the test materials. Temperatures ranged from 1200 to 1600 degrees Fahrenheit during these subsequent tests. Test results indicated appreciable volume reduction in the pyrolyzed material after it cooled.

It can be determined from the foregoing discussion that an advanced microwave system according to example embodiments of the present invention has applicability in pyrolyzing incoming waste material, including a variety of waste media and admixtures, to achieve significant volume reduction of the total waste product. In some embodiments of the present invention, the microwave system is supplemented by a vitrification system that uses inductive heating or some other method of heating to assist in pyrolyzing and melting the incoming waste material.

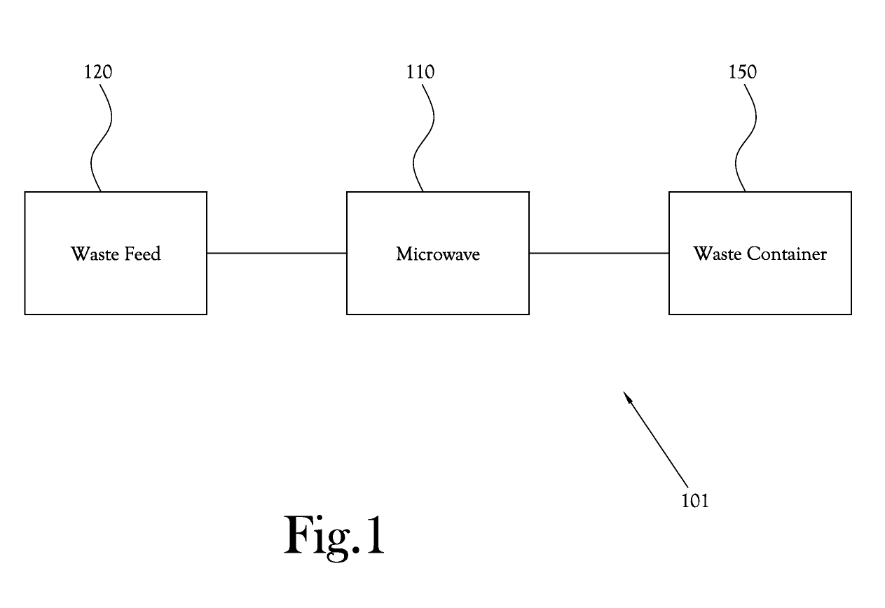

In one embodiment of the present invention, illustrated by the block diagram in FIG. 1, an advanced microwave system 101 comprises a microwave applicator 110 positioned to direct microwaves at waste material moving between a waste feed source 120 and a waste container 150.

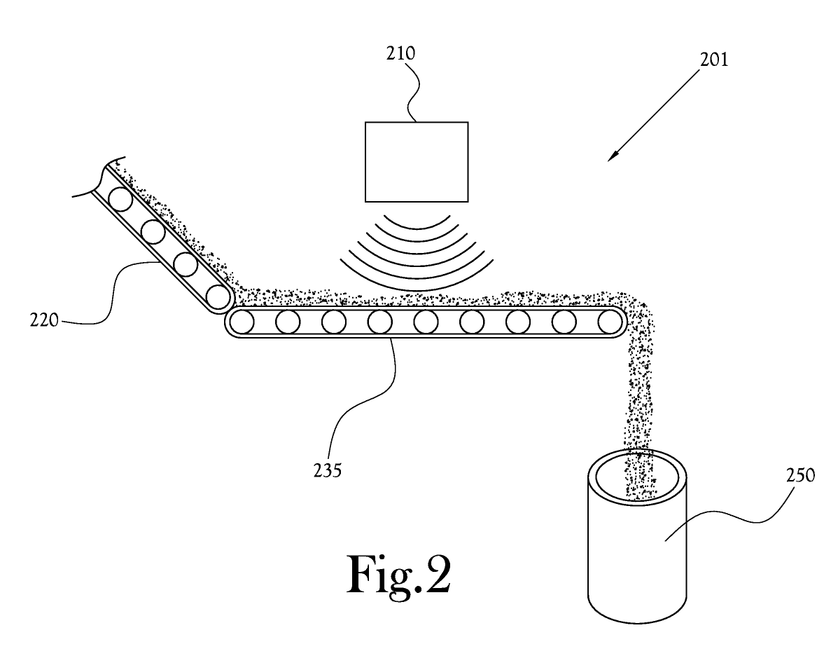

One embodiment of the present invention is illustrated by the representative diagram in FIG. 2. In the illustrated embodiment, a layer waste material is treated by microwaves on a conveyor before being deposited within the final waste container. An advanced microwave system 201 comprises a microwave applicator 210 positioned to direct microwaves at a layer of waste material moving on a conveyor 235 between a waste feed 220 and a waste container 250. Because microwaves will only penetrate waste material to a certain thickness (which will vary to some degree with the exact composition of the waste material), it is important that the maximum thickness of the layer of waste material on the conveyor 235 not be greater than the maximum penetration of the microwaves. In several embodiments, the layer of waste material deposited by the waste feed 220 onto the conveyor 235 has a thickness of between one and two inches.

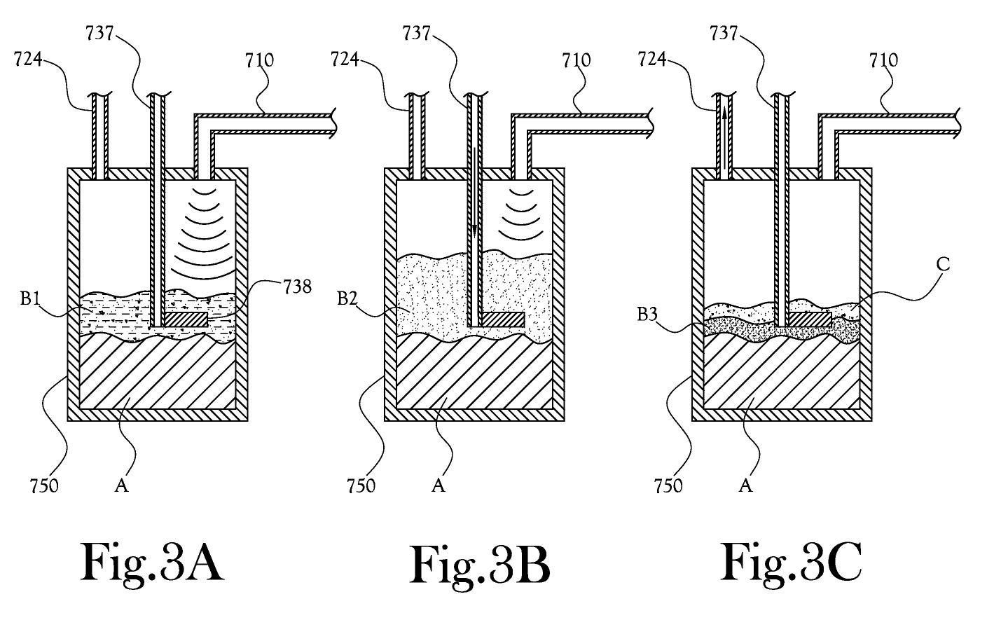

One embodiment of a microwave system according to the present invention is illustrated in the section diagrams in FIGS. 3A, 3B, and 3C. In the illustrated embodiment, a thin layer of waste material is treated by microwaves after it has been deposited within the final waste container. As shown in the illustration, beginning with FIG. 3A, waste material enters the container 750 through a feed tube 737 that penetrates the interior of the container 750. A microwave waveguide 710 is positioned to direct microwaves at the top layer of waste material in the container 750. The feed tube 737 and microwave waveguide 710 have access to the interior of the container 750 through a fill-head cap 748, which also includes an off-gas outlet 724 to allow evaporated water and other gases expelled from the waste material to leave the container 750. The illustrations in FIGS. 3A through 3C show a filling and microwave-treatment process already in progress. Thus, as seen in FIG. 3A, the container contains a lower layer of final waste product A. On top of the lower layer of final waste product A, the feed tube 737 deposits a thin layer B1 of waste material. The waveguide 710 then directs microwaves at the thin layer B1 of waste material, thereby drying, and in some cases pyrolyzing, the waste material. Because microwaves will only penetrate waste material to a certain thickness (which will vary to some degree with the exact composition of the waste material), it is important that the layer B1 of waste material not be thicker than the maximum penetration of the microwaves. In several embodiments, the layer B1 deposited by the feed tube 737 has a thickness of between one and two inches. In many cases, the microwave drying and heating of the top layer of waste material B1 causes the waste material to foam or otherwise expand; in many cases, the microwave treatment initially results in an expanded, low density layer B2 of carbonized waste material, as shown in FIG. 3B. Foaming or other expansion of carbonized waste material is especially common when treating radioactive organic resin wastes. For such cases where an expanded, low density layer B2 of waste material forms, the feed tube 737 in many embodiments is equipped with a stirrer, paddle or mixer 738 at the lower end of the feed tube 737. During and after the microwaving of the top layer of waste material, when expanded, low density layer B2 forms, the stirrer, paddle or mixer 738 operates to stir and compact the waste material to form a compacted layer B3, as seen in FIG. 3C. When the topmost layer of waste material has been microwaved and compacted, a new layer C of waste material is added through the feed tube 737, and the process is repeated. Additional layers of waste material are added, microwaved, and compacted until the total amount of final waste product fills the safe storage capacity of the container 750.

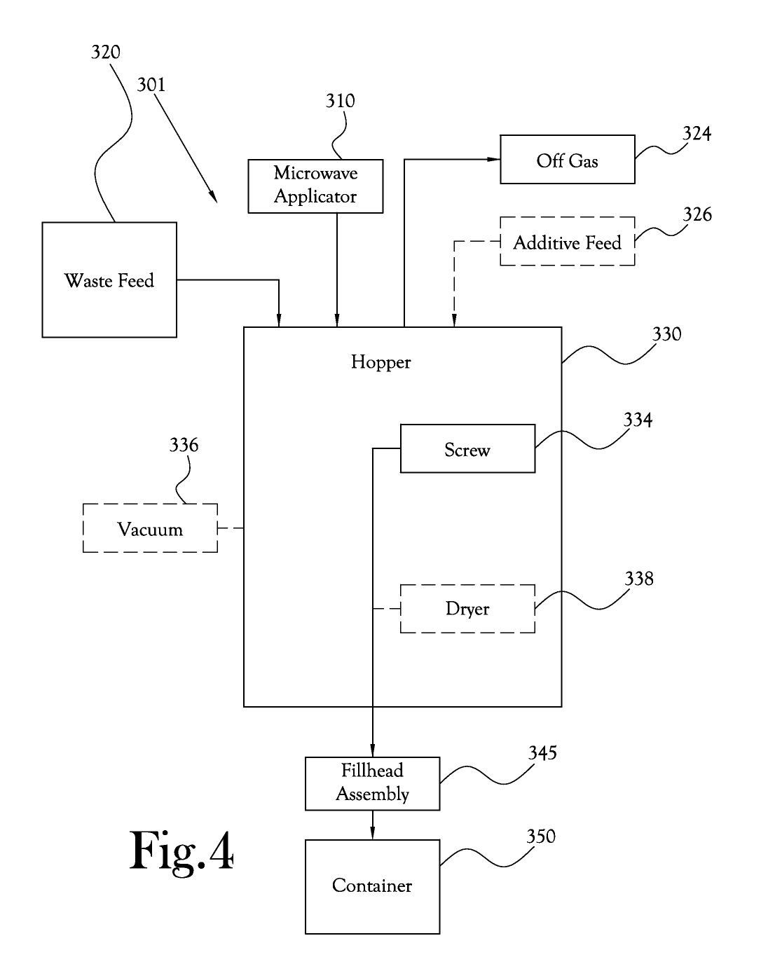

One embodiment of a microwave system according to the present invention is illustrated in the block diagram in FIG. 4. In the illustrated embodiment, a layer of waste material is treated by microwaves within a hopper before being deposited within the final waste container. The advanced microwave system 301 comprises a microwave applicator 310 and a hopper 330. The hopper 330 receives waste material from a waste feed 320. In many embodiments, the hopper 330 includes a conical funnel that receives incoming waste material from the waste feed 320 and directs the waste material toward a fill-head cap 345 positioned over a waste container 350. In the illustrated embodiment, the system 301 further includes a screw or auger 334 operating within the interior of the hopper 330. In various embodiments, the system 301 also includes one or more additional components, such as a vacuum component 336, which lowers the air pressure within the hopper and lowers the temperature at which moisture within the waste material evaporates; or a combination mixer-dryer 338, which mixes the waste material and uses a non-microwave-based method of heating and drying the waste material, thereby supplementing the heating and drying performed by the microwave applicator 310. In several embodiments of the present invention, the system 301 also includes an off-gas line 324 running from the hopper 330 for removing evaporated water and other gases expelled from the waste material during the microwave treatment within the hopper 330. In some embodiments, the system 301 further includes an additive input line 326 for supplying additive chemicals or materials to the mixture of waste material in the hopper 330, such additive chemicals or materials in some cases including, for example, a chemical catalyst or a material to help initiate a vitrification process.

In the illustrated embodiment, waste material (usually in the form of a slurry) enters the hopper 330 from the waste feed 320. As waste material fills the bottom of the hopper 330, microwaves from the microwave applicator 310 heat and dry the waste material, removing moisture from the waste material; in some cases, treating the waste material with microwaves also pyrolyzes the waste material, breaking down the crystalline structures of some waste material or carbonizing organic waste material. After compaction, the desiccated and often pyrolized waste material thereby has a significantly smaller volume than the incoming waste material had before microwave treatment. In some embodiments, a screw or auger 334 stirs and churns the waste material within the hopper 330, thereby bringing waste material from the bottom of the mass of waste material inside the hopper 330 to the top of the mass waste material, where microwaves can better penetrate and dry the waste material. The screw or auger 334 further assists in the drying process, keeps the drying waste material from solidifying into hard clumps, and prevents waste material from sticking to the walls of the hopper 330. After the waste material has been treated by microwaves within the hopper, the treated waste material moves from the hopper 330 through a fill-head assembly 345 into the waste container 350. In many embodiments, the waste container 350 that receives the radioactive waste material is a long-term or permanent storage container for the final waste product.

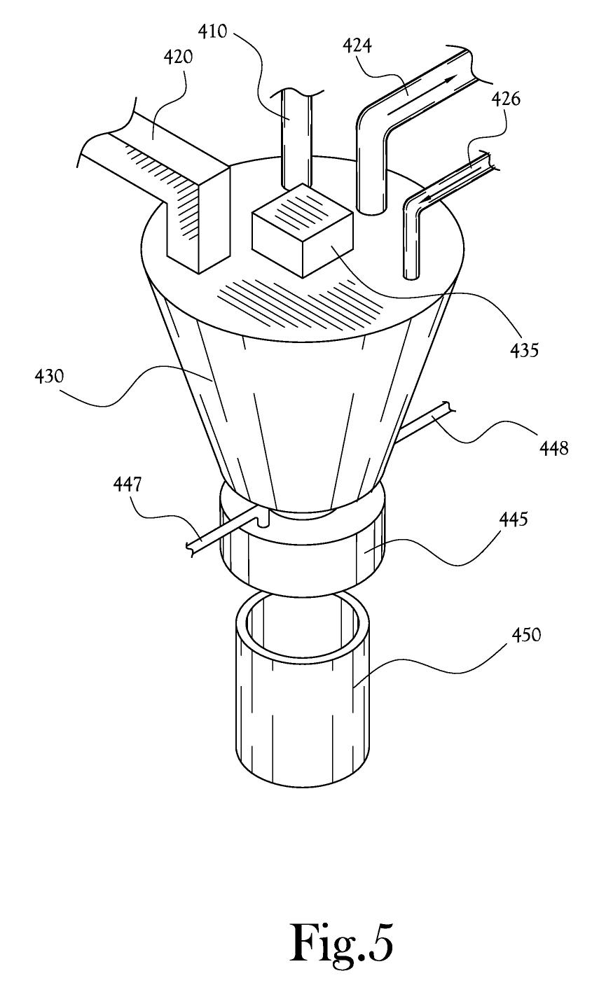

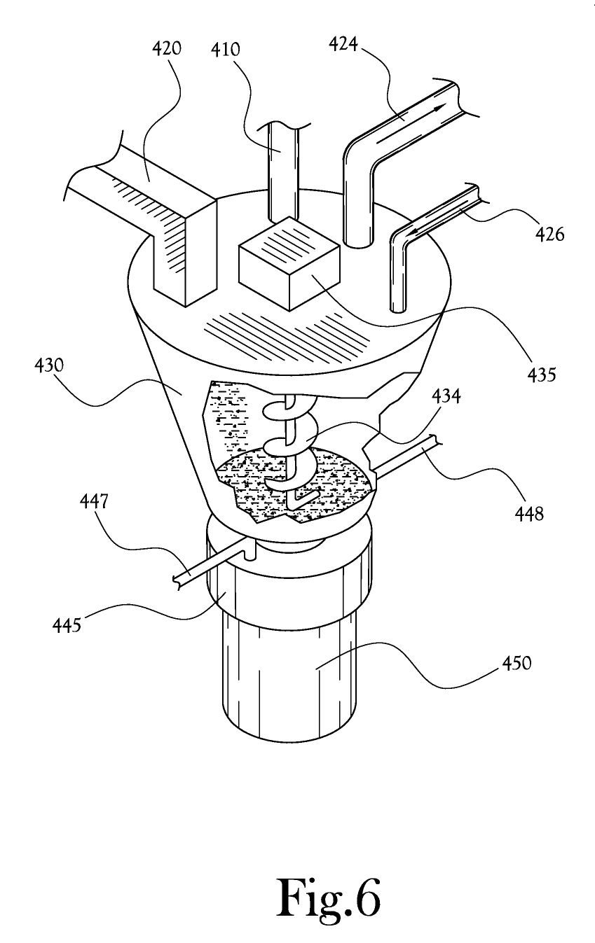

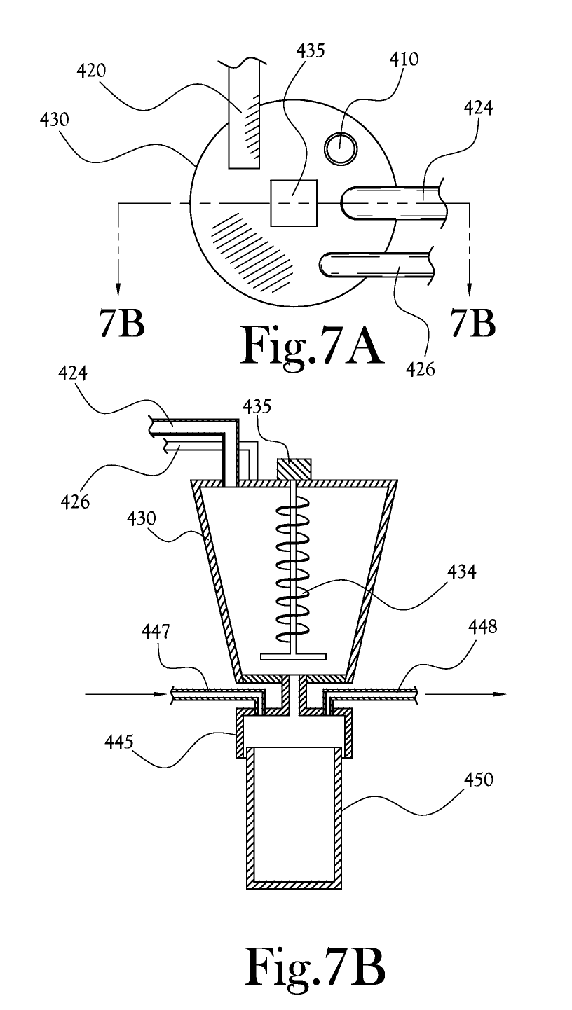

FIGS. 5, 6, 7A, and 7B illustrate another embodiment of the present invention in which a layer of waste material is treated by microwaves within a hopper before being deposited within a waste container or vitrification module (hereinafter “waste container”). FIG. 5 shows a perspective view of a conical hopper 430 positioned over a waste container 450. A microwave applicator or waveguide 410 is positioned to direct microwaves into the interior of the conical hopper 430. As shown in the cut-away view of FIG. 6 and in the section view in FIG. 7B, waste material enters the hopper 430 through a waste feed 420. Waste material collects toward the bottom of the hopper 430, and microwave applicator or waveguide 410 directs microwaves at the waste material. In several embodiments of the present invention, the system also includes an off-gas line 424 running from the hopper 430 for removing evaporated water and potentially other gases expelled from the waste material during the microwave treatment within the hopper 430. In some embodiments, the system further includes an additive input line 426 for supplying additive chemicals or materials to the mixture of waste material in the hopper 430, such additive chemicals or materials in some cases including, for example, a chemical catalyst or a material to help initiate a granularization (described as a break over in drying terminology) or vitrification process. A screw or auger 434, controlled by a driving mechanism 435, stirs and churns the waste material in the hopper 430, thereby bringing waste material from the bottom of the mass of waste material inside the hopper 430 to the top of the mass waste material, where microwaves can better penetrate and react with the waste material. The screw or auger 434 further assists in the drying process, keeps the drying waste material from solidifying into hard clumps, and prevents waste material from sticking to the walls of the hopper 430. After the waste material has been treated by microwaves within the hopper, the treated waste material moves from the hopper 430 through a fill-head assembly 445 into the waste container 450. In some embodiments, the fill-head assembly 445, which covers and protects the interior of the waste container 450, includes an off-gas line 447 and a purge gas line 448; after the treated waste material has been deposited in the waste container 450, very often reactions continue within the mixture of waste material as it becomes the final waste product, and those reactions expel gases from mass of waste material within the waste container 450; these gases are removed from the interior of the container through the off-gas line 447, frequently with the assistance of purge gas (such as an inert gas like Argon) from the purge gas line 448. In many embodiments, the waste container 450 that receives the radioactive waste material is a long-term or permanent storage container for the final waste product.

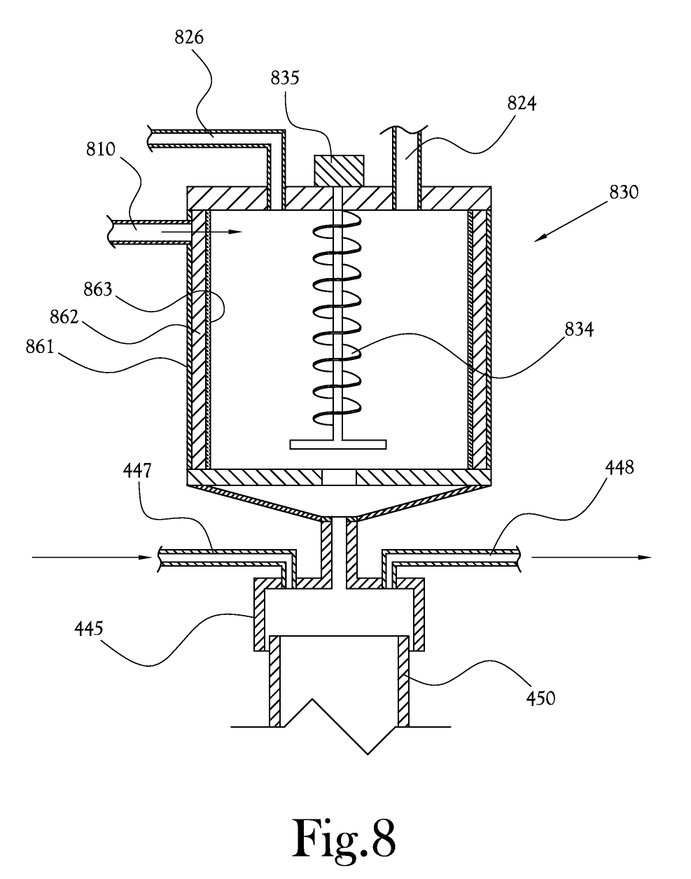

FIG. 8 illustrates another embodiment of the present invention in which a layer of waste material is treated by microwaves within a hopper before being deposited within a waste container. FIG. 8 shows a perspective view of a hopper 830 positioned over a waste container 450. Several features of the embodiment illustrated in FIG. 8 are similar to features in the embodiment illustrated in FIGS. 5 through 7B—for example, the fill-head assembly 445, the off-gas line 447, and the purge gas line 448 are largely the same as in FIGS. 5 through 7B. In this embodiment, a microwave applicator or waveguide 810 is positioned to one side of the hopper 830 and directs microwaves into the interior of the hopper 830. As in the embodiment illustrated in FIGS. 5 through 7B, waste material enters the hopper 830 through a waste feed; waste material collects toward the bottom of the hopper 830; and the microwave applicator or waveguide 810 directs microwaves at the waste material. In the illustrated embodiment, the hopper 830 has walls that comprise a series of layers, including an outer layer 861 of stainless steel or similar metal; a middle layer 862 of plastic or Teflon, for insulation; and an inner layer 863 fabricated from a ceramic material for both thermal protection and abrasion protection. The microwave applicator or waveguide 810 is positioned near an aperture defined by the metal outer layer 861; microwaves enter the hopper 830 as indicated by the arrow in FIG. 8 near microwave applicator or waveguide 810. The microwaves pass through the middle layer 862 and the inner layer 863, which are fabricated from materials that are transparent to microwaves; however, once inside the hopper 830, the microwaves are reflected by the metal outer layer 861 and continue to travel around the interior of the hopper 830 and pass through the radioactive waste material inside the hopper 830. In the illustrated embodiment, the system also includes an off-gas line 824 running from the hopper 830 for removing evaporated water and other gases expelled from the waste material during the microwave treatment within the hopper 830. In some embodiments, the system further includes an additive input line 826 for supplying additive chemicals or materials to the mixture of waste material in the hopper 830, such additive chemicals or materials in some cases including, for example, a chemical catalyst or a material to help initiate a granularization (described as a break over in drying terminology) or vitrification process. A screw or auger 834, controlled by a driving mechanism 835, stirs and churns the waste material in the hopper 830, thereby bringing waste material from the bottom of the mass of waste material inside the hopper 830 to the top of the mass waste material, where microwaves can better penetrate and react with the waste material. After the waste material has been treated by microwaves within the hopper 830, the treated waste material moves from the hopper 830 through the fill-head assembly 445 into the waste container 450.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, I claim:

1. A system for treating radioactive waste material comprising:
a waste container for receiving radioactive waste material;
a waste feed for supplying a layer of radioactive waste material, the layer of radioactive waste material having a thickness;
a conveyor for receiving the layer of radioactive waste material and conveying it to said waste container; and
a microwave source to direct microwaves at a portion of the thin layer of radioactive waste material on said conveyor, such that microwaves penetrate the entire thickness of the layer of radioactive waste material, said microwave source positioned such that all radioactive waste material deposited onto said conveyor by said waste feed is penetrated by microwaves before being received by said waste container, such that the microwaves directed at the radioactive waste material remove moisture from the radioactive waste material.

2. The system of claim 1 further comprising a waveguide to focus microwaves from the microwave source.

3. The system of claim 1 wherein the microwave source comprises a microwave applicator.

4. The system of claim 1 wherein said waste container is suitable for long-term storage of the radioactive waste material.

5. A system for treating radioactive waste material comprising:
a waste container for receiving radioactive waste material;
a waste feed for supplying radioactive waste material;
a hopper for receiving radioactive waste material from said waste feed and for channeling the radioactive waste material into said waste container; and
a microwave source to direct microwaves at the radioactive waste material in said hopper, such that microwaves penetrate the entire thickness of the layer of radioactive waste material, such that the microwaves directed at the radioactive waste material remove moisture from the radioactive waste material.

6. The system of claim 5 wherein the system includes a screw within said hopper for stirring the waste material.

7. The system of claim 5 wherein the system includes an auger within said hopper for stirring the waste material.

8. The system of claim 5 wherein said waste container is suitable for long-term storage of the radioactive waste material.

9. A system for treating radioactive waste material comprising:
a waste container for receiving radioactive waste material;
a waste feed tube for depositing a layer of radioactive waste material within said waste container, the layer of radioactive waste material having a thickness; and
a microwave source to direct microwaves at the layer of radioactive waste material deposited in said waste container, such that microwaves penetrate the entire thickness of the layer of radioactive waste material, such that the microwaves directed at the radioactive waste material remove moisture from the radioactive waste material.

10. The system of claim 9 wherein the system includes a stirrer for stirring the layer of radioactive waste material within the waste container.

11. The system of claim 9 wherein said waste container is suitable for long-term storage of the radioactive waste material.

12. A method of treating radioactive waste material, comprising:
forming a layer of radioactive waste material to a predetermined thickness;
directing microwaves to the layer of radioactive waste material such that the microwaves penetrate the predetermined thickness of the layer; and
delivering the layer of waste material to a waste container for long-term storage.

13. The method of claim 12 wherein the predetermined thickness is substantially equal to a depth of penetration of the microwaves to the radioactive waste material.

14. The method of claim 13 wherein the delivering operation occurs before the directing operation, the method further comprising:
repeating the forming, directing, and delivering operations such that a first layer of radioactive waste material is delivered to a bottom of the waste container, and subsequent layers of radioactive waste material are delivered on top of the previous layer such that microwaves are directed to the most recently delivered layer until the waste container is filled.

15. The method of claim 14 wherein the directing operation comprises:
stirring the most recently delivered layer during the direction operation to facilitate drying of the waste material; and
compacting the most recently delivered layer against a previous layer before a subsequent layer of radioactive waste material is delivered to the waste container.

16. The method of claim 12 further comprising:
continuously conveying layers of radioactive materials to the waste container during the directing and delivering operations such that the directing operation occurs before the delivering operation.

17. The method of claim 12 further comprising:
conveying the layer of waste material to a hopper to perform the directing operation; and
stirring the layer of waste material within the hopper during the directing operation to facilitate heating and drying of the waste material.

18. The method of claim 17, wherein the directing operation further comprises:
lowering air pressure surrounding the layers radioactive materials to lower the temperature at which moisture within the waste material evaporates; and
supplying additive chemicals to the layers of radioactive materials to facilitate a vitrification process.
